(19) United States
(12) Patent Application Publication
(10) Pub. No.: US 2008/0050636 A1
(43) Pub. Date: Feb. 28, 2008

(54) MIXER FOR LIQUID FUELS

(76) Inventors: HSI-MING SHU, TAIPEI (TW); TSANG-MING CHANG, TAIPEI (TW); WEI-LI HUANG, TAIPEI (TW); CHIEN-AN CHEN, KAOHSIUNG (TW); WEN JUI CHUANG, KAOHSIUNG (TW)

Correspondence Address: G. LINK CO., LTD., 3550 BELL ROAD, MINOOKA, IL, 60447, US

(21) Appl. No.: 11/840,932

(22) Filed: Aug. 18, 2007

(30) Foreign Application Priority Data
Aug. 22, 2006 (TW) 095214828

(51) Int. Cl. H01M 8/04

(52) U.S. Cl. 429/34

(57) ABSTRACT

A liquid fuel mixer is disclosed, which is used to store liquid fuels for a fuel cell. The liquid fuel mixer includes a casing, one or more radiators and a gas permeable but liquid impermeable film. The casing forms a first internal compartment and a second internal compartment, and the first internal compartment is adjacent to the second internal compartment. The casing next to and separating the first internal compartment from the second internal compartment includes at least one vent and at least one drain. The second internal compartment contains the liquid fuels. The radiators are disposed in the first internal compartment. The gas permeable but liquid impermeable film is disposed on the vent. To avoid water condensing on the walls, the bottom of the first internal compartment includes a slopping channel and/or a flow-guilding channel, and the drain is disposed on the end of the lower portion of the slopping channel or the flow-guilding channel.

### FIELD OF THE INVENTION

The present invention relates to a mixer for liquid fuels adapted for storing liquid fuels in a fuel cell, and more particularly, to a mixer that can recycle aqueous products from a fuel cell.

### BACKGROUND OF THE INVENTION

A fuel cell is a power generator, which converts chemical energy stored within fuels and oxidants directly into electric energy through reactions of its electrodes. Presently, the kinds of fuel cells are diverse. According to the properties of their electrolytes, fuel cells can be divided into five types including alkaline fuel cells, phosphoric acid fuel cells, proton exchange membrane fuel cells, fused carbonate fuel cells, and solid oxide fuel cells. Wherein, a proton exchange membrane fuel cell includes a so-called direct methanol fuel cell (DMFC), which directly uses methanol as fuel without modifying the same into hydrogen gas. This is also at present a technique that can generate relatively high power. Such fuel cells may be applied to large power plants, vehicular power generators, portable power supplies, and so forth.

Currently, manufacturers face many technical challenges in the field of fuel cells, one of which is the design of fuel supply systems. Other issues include how to recycle aqueous products produced by chemical reactions of fuel cells, and how to miniaturize fuel cells and thus reduce their volume.

### SUMMARY OF THE INVENTION

It is a primary object of the invention to provide a mixer for liquid fuels that is adapted to recycle aqueous products from a fuel cell, and to store liquid fuels required by a fuel cell.

It is another object of the invention to provide a mixer for liquid fuels that integrates the structures of a condenser and a fuel mixing tank. Consequently, the overall volume of a fuel cell is decreased.

In accordance with the aforementioned objects of the invention, a liquid fuel mixer is provided, which is used to store liquid fuels for a fuel cell. The liquid fuel mixer includes a casing, one or more radiators, and a gas permeable but liquid impermeable film. The casing forms a first internal compartment and a second internal compartment, and the first internal compartment is adjacent to the second internal compartment. The casing next to and separating the first internal compartment from the second internal compartment includes at least one vent and at least one drain. The second internal compartment contains the liquid fuel. The radiators are disposed in the first internal compartment. The gas permeable but liquid impermeable film is disposed on the vent.

### BRIEF DESCRIPTION OF THE DRAWINGS

The detail structure, the applied principle, the function and the effectiveness of the present invention can be more fully understood with reference to the following description and accompanying drawings, in which:

FIG. 1 shows the cross section of a mixer for liquid fuels according to one embodiment of the invention;

FIG. 2 is a schematic diagram transected along the line I-I in FIG. 1; and

FIG. 3 shows the cross section of a mixer for liquid fuels according to another embodiment of the invention.

### DETAILED DESCRIPTION OF THE INVENTION

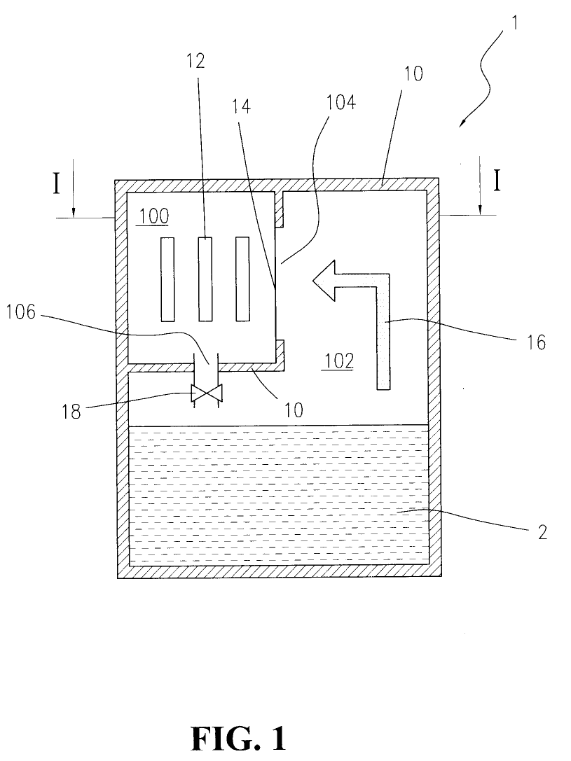

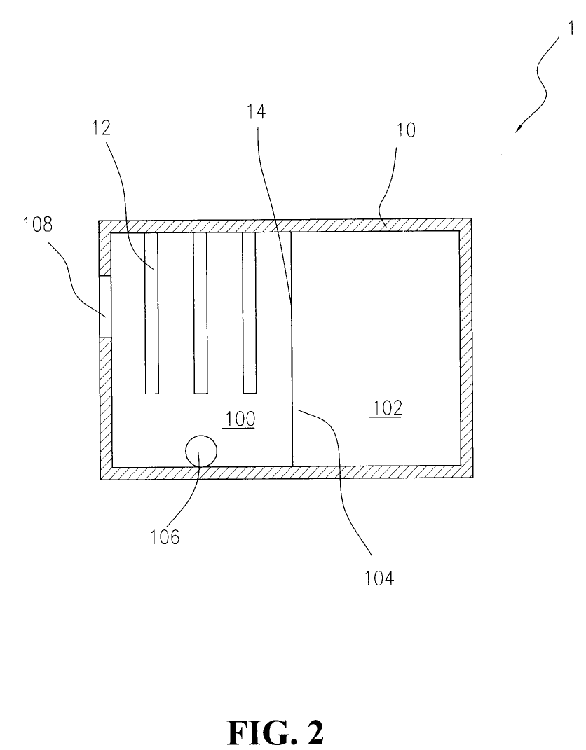

FIG. 1 shows the cross section of a mixer for liquid fuels according to one embodiment of the invention. FIG. 2 is a schematic diagram transected along the line I-I in FIG. 1. A mixer 1 for liquid fuels is provided to store liquid fuels 2 used in a fuel cell. In one aspect, the fuel cell may be a direct methanol fuel cell (DMFC), and the mixer 1 for liquid fuels stores a methanol solution 2 used in the DMFC. Of course, the embodiments of the invention can be applied to fuel cells using other kinds of liquid fuels.

Referring to FIG. 1, the mixer 1 for liquid fuels includes a casing 10, one or more radiators 12 and a gas permeable but liquid impermeable film 14. The casing 10 forms a first internal compartment 100 and a second internal compartment 102, and the first internal compartment 100 is adjacent to the second internal compartment 102. As shown in FIG. 1, the first internal compartment 100 is adjacent to and above the second internal compartment 102. The second internal compartment 102 may include an L-shaped space, which is not intended to limit the scope and spirit of the invention. The casing 10 that is next to and separates the first internal compartment 100 from the second internal compartment 102 includes a vent 104 and a drain 106. In one embodiment, the bottom of the first internal compartment 100 includes a slopping channel and/or a flow-guilding channel. Also, the drain 106 is disposed on the end of the lower portion of the slopping channel or flow-guilding channel, so as to prevent water from condensing on the walls.

The radiators 12 are disposed in the first internal compartment 100, so the first internal compartment 100 may serve as a condensing partition. Accordingly, the mixer 1 for liquid fuels has the functions of a conventional condenser. On the other hand, the second internal compartment 102 is provided to contain liquid fuels 2.

The radiator 12 may adopt a structure with radiating fins. As shown in FIG. 2, the radiators 12 may be positioned on the wall of the casing 10 in the first internal compartment 100.

The gas permeable but liquid impermeable film 14 is placed on the vent 104. In one embodiment, the gas permeable but liquid impermeable film 14 covers the vent 104 tightly, and is fixed on the casing 10. Due to the presence of the gas permeable but liquid impermeable film 14, vapor 16 from liquid fuels 2 evaporating at high temperatures in the second internal compartment 102 flows into the first internal compartment 100 through the gas permeable but liquid impermeable film 14. Then vapor 16 is condensed in the first internal compartment 100.

The mixer 1 for liquid fuels further includes a check valve 18 disposed on the drain 106. The check valve 18 allows condensed water in the first internal compartment 100 to flow towards the second internal compartment 102 uni-directionally. Conversely, the liquid fuels 2 in the second internal compartment 102 overflowing onto the drain 106 do not flow into the first internal compartment 100 because the check valve 18 prevents backflow.

As shown in FIG. 2, an air inlet 108 is disposed on the casing 10 outside the first internal compartment 100, and is in fluid communication with the first internal compartment 100. The air inlet 108 is pivotally connected to an outlet of a fuel cell (not shown) for exhausting gaseous products. In the case of a DMFC, the air inlet 108 is pivotally connected to an outlet of the DMFC for exhausting vaporous products.

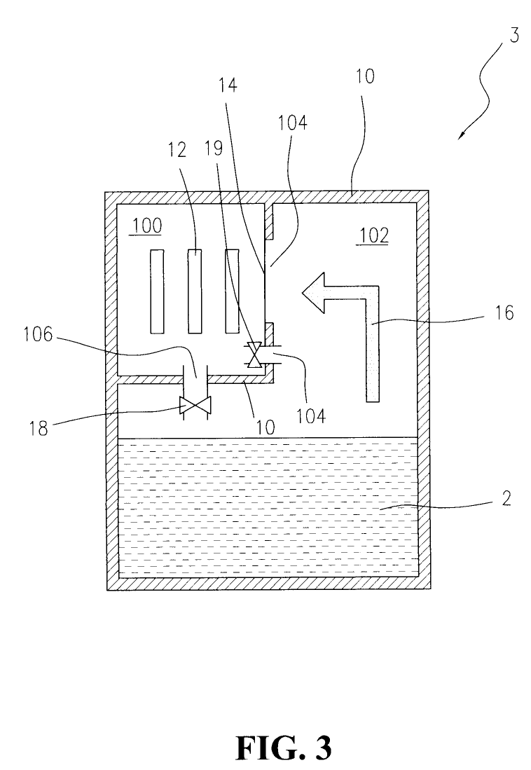

FIG. 3 shows the cross section of a mixer for liquid fuels according to another embodiment of the invention. The casing 10 of a mixer 3 for liquid fuels, which separates the first internal compartment 100 from the second internal compartment 102, includes at least one vent 104. The mixer 3 for liquid fuels further includes a pressure valve 19 disposed on the vent 104. The pressure valve 19 is used to maintain the pressure within the second internal compartment 102 at a secure level, so as to prevent abnormal pressure from damaging the gas permeable but liquid impermeable film 14. If the vapor pressure 16 is higher than a predetermined value, the pressure valve 19 is actuated responsively to discharge some vapor 16 into the first internal compartment 100. When the pressure is reduced below a predetermined value, the pressure valve 19 is closed slowly and automatically.

For higher efficiency of condensing in the first internal compartment 100 of the mixers 1, 3 for liquid fuels, the casings 10 of the mixers 1, 3 for liquid fuels may be made of a thermally conductive material, preferably a metal that is treated by an acid-proof process. Or, the casings 10 of the mixers 1, 3 for liquid fuels may be made from a plastic material that is treated by an acid-proof process, such as plastic.

According to the mixers 1, 3 for liquid fuels in the invention, the first internal compartment 100 is used as a condenser, and the second internal compartment 102 is used to store liquid fuels 2 for a fuel cell. Hence, the space of the fuel cell is well deployed so that the total volume required for the fuel cell is decreased greatly.

Furthermore, the condensed water in the first internal compartment 100 may be applied to dilute liquid fuels without requiring the use of an aqueous solution tank, which is essential for a conventional fuel cell. This makes it feasible to miniaturize fuel cells. In addition, the condensed water in the first internal compartment 100 may flow downstream towards the second internal compartment 102 without requiring a pump, which is also beneficial for miniaturizing fuel cells.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. A liquid fuel mixer for storing liquid fuels of a fuel cell, the liquid fuel mixer comprising:
a casing to form a first internal compartment and a second internal compartment, wherein the first internal compartment is adjacent to the second internal compartment, the casing next to and separating the first internal compartment from the second internal compartment comprises at least one vent and at least one drain, and the second internal compartment contains the liquid fuels;
one or more radiators disposed in the first internal compartment; and
a gas permeable but liquid impermeable film disposed on the vent.

2. The liquid fuel mixer of claim 1, further comprising a check valve disposed on the drain.

3. The liquid fuel mixer of claim 1, further comprising a pressure valve disposed on the vent.

4. The liquid fuel mixer of claim 1, wherein the first internal compartment is adjacent to and above the second internal compartment.

5. The liquid fuel mixer of claim 1, wherein the second internal compartment comprises an L-shaped space.

6. The liquid fuel mixer of claim 1, wherein the radiator comprises a radiating fin.

7. The liquid fuel mixer of claim 1, wherein the casing comprises an air inlet, the air inlet is in fluid communication with the first internal compartment, and the air inlet is pivotally connected to an outlet of the fuel cell for exhausting gaseous products.

8. The liquid fuel mixer of claim 1, wherein the bottom of the first internal compartment comprises a slopping channel and/or a flow-guilding channel.

9. The liquid fuel mixer of claim 8, wherein the drain is disposed on an end of the lower portion of the slopping channel and/or the flow-guilding channel.

10. The liquid fuel mixer of claim 1, wherein the casing is made of a thermally conductive material.

11. The liquid fuel mixer of claim 10, wherein the thermally conductive material is metal treated by an acid-proof process.

12. The liquid fuel mixer of claim 1, wherein the casing is made of a plastic material.

13. The liquid fuel mixer of claim 12, wherein the plastic material is a material treated by an acid-proof process.

14. The liquid fuel mixer of claim 1, wherein the liquid fuels comprise a methanol solution.

15. The liquid fuel mixer of claim 1, wherein the fuel cell is a direct methanol fuel cell.
